(19) United States
(12) Patent Application Publication
(10) Pub. No.: US 2010/0082715 A1
(43) Pub. Date: Apr. 1, 2010

(54) Reduced-Resource Block Thin Provisioning

(76) Inventors: Karl Dohm, Colorado Springs, CO (US); Shad Jeseritz, Colorado Springs, CO (US); Rodger Daniels, Boise, ID (US); William Brian Bouldin, Colorado Springs, CO (US); Andrew Westra, Colorado Springs, CO (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/242,186

(22) Filed: Sep. 30, 2008

(51) Int. Cl. G06F 12/02

(52) U.S. Cl. 707/822; 707/E17.01; 711/E12.002

(57) ABSTRACT

A computer-executed method reduces a storage array's physical spindle requirements, leading to reduced power and resource costs, as compared to block thin provisioning. A computer-executed method for managing access of a plurality of applications to a storage array comprises monitoring storage space usage in a file system, and modifying size of logical units by selective increases and decreases based on the storage usage.

### BACKGROUND

Traditional thin provisioning, as implemented on block storage arrays in industry, has an inherent space efficiency problem. Block devices cannot discern whether a LUN logical block which has been written contains valid data, or contains data that once was valid but no longer serves any purpose. Many different host processes can cause the latter condition to occur, for example defragment, drive format, installation of a service pack, disk cleanup, and others. Additionally, some operating systems have policies that favor use of blocks which have never been written to preserve maximum history in an undelete capability. The constant creation, deletion, and growth of files in such operating systems result in wasted space in storage. Over time, the allocated “thin” space increases while the actual space used by data, such as customer data, may be growing more slowly, remaining steady, or even shrinking.

### SUMMARY

Embodiments of a computer-executed method reduce a storage array's physical spindle requirements, leading to reduced power and resource costs as compared to block thin provisioning. A computer-executed method for managing access of a plurality of applications to a storage array comprises monitoring storage space usage in a file system, and modifying size of logical units by selective increases and decreases based on the storage usage.

### BRIEF DESCRIPTION OF THE DRAWINGS

Embodiments of the invention relating to both structure and method of operation may best be understood by referring to the following description and accompanying drawings:

FIGS. 1A and 1B are schematic block diagrams illustrating embodiments of a computer-implemented system that reduces power and resource costs of block thin provisioning;

FIG. 2 is a schematic block diagram showing another embodiment of a computer-implemented system that reduces power and resource costs of block thin provisioning;

FIGS. 3A through 3F are flow charts illustrating one or more embodiments or aspects of a computer-executed method that reduces power and resource costs of block thin provisioning;

FIGS. 4A and 4B are block and pictorial diagrams depicting operation of traditional thin provisioning in block storage, showing storage as seen by a host in comparison to actual operation of the array;

FIG. 5 is a pictorial view showing consequences of traditional thin provisioning; and

FIG. 6 is a pictorial diagram showing operation of the illustrative improved thin provisioning.

### DETAILED DESCRIPTION

Embodiments of systems and methods are disclosed which enable improvement of block thin provisioning to reduce power, space, and array cost.

In the illustrative systems and methods, traditional thin provisioning is replaced by a technique which achieves greater efficiency. As proposed, spindle space in storage is maintained proportional to the file system capacity which is actually used. Storage space is reclaimed if the file system decreases in size, a result which is not possible in traditional block thin provisioning. Simple operations such as deletion of a large file or database or a cut/paste of data from one logical unit to another, are real-world examples of file system shrinkage which are accommodated in the illustrative technique.

In an example embodiment, a specialized host side process can be added to enhance the block storage approach to traditional thin provisioning. The host side executable can interact with a host operating system to determine actual space used in a file system, and manage appropriate grow or shrink operations in cooperation with host operating system functions. A logical unit is sized to attain a close fit relative to actual space usage. The technique can improve over traditional thin provisioning for which a block in storage that is written cannot be discerned to be used or unused.

The improved technique for thin provisioning can reduce power, space, and array cost, thereby reducing energy expenditure in data center heating and cooling, and improving green capability of storage.

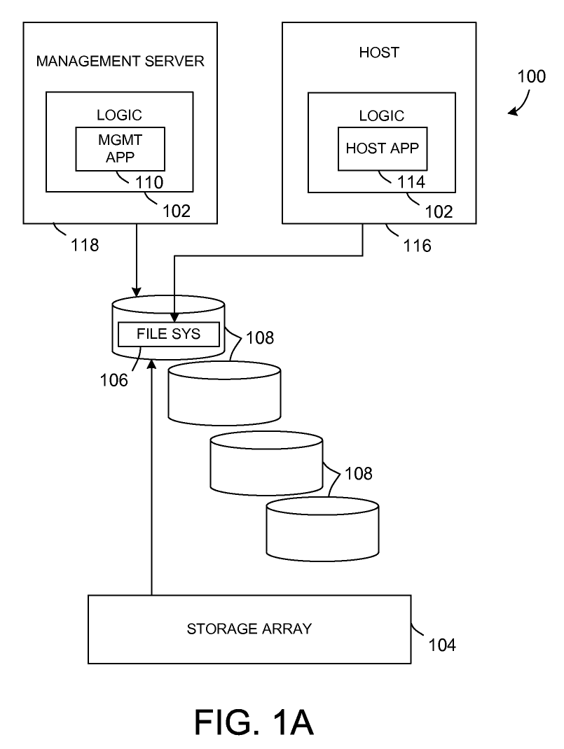

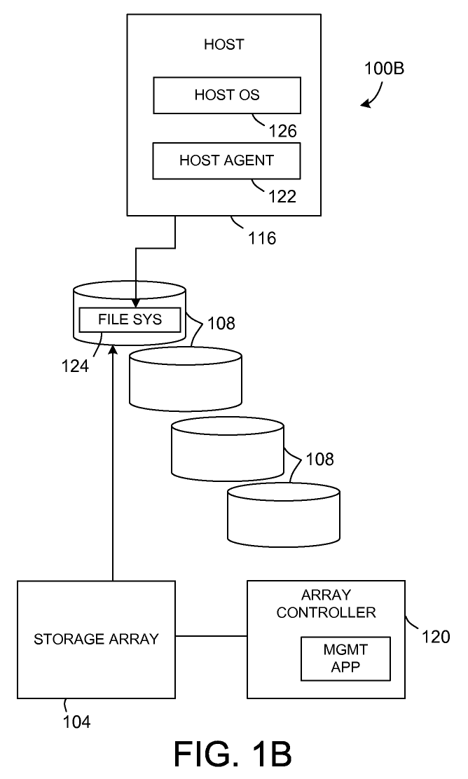

Referring to FIG. 1A, a schematic block diagram illustrates an embodiment of a computer-implemented system 100 that reduces power and resource costs of block thin provisioning. The illustrative computer-implemented system 100 comprises logic 102 that manages access of a plurality of applications to a storage array 104 by monitoring storage space usage in a file system 106, and sizing logical units 108 by selective increases and decreases based on the storage usage.

In various embodiments, implementations, and configurations, the logic 102 can execute from any suitable single device, such as a host, client, server, storage array, array controller, management device, or the like; or can be distributed among multiple devices.

In an example embodiment, the system 100 can comprise a management application 110 and a host application 114. The host application 114 that executes on a host 116 and monitors storage space usage. The host application 114 sends information of the storage space usage to the management application 110. The management application 110 responds to the storage space usage information by sizing the logical units to fit the storage space usage.

The host 116 can contain the logical units 108 that are presented and sized.

The host application 114 can send information of the storage space usage to the management application 110 at selected events or in selected conditions. In various implementations, the host application can send the information at selected-duration intervals or according to other schemes. For example, the host application 114 can send an interrupt to management application 110 when a predetermined amount of growth or reduction has taken place in the file system, such as based on a preset threshold. In another implementation, the host application 114 can poll periodically and send a trigger to the management application 110 in the event of a predetermined condition. In some applications, the management application 110 can trigger sampling, although a system is typically more robust if the host performs the monitoring and sends a trigger to the management application 110.

Logic in either the management application 110 or the host application 114 can detect mismatches between logical unit size and file system size, and modify the size of the logical unit 108 by increasing or decreasing logical unit size based on magnitude and direction of the mismatch. The direction of the mismatch specifies whether the file system is growing or reducing in size. The location of the logic for detecting mismatches can be determined based on operating conditions of the system implemented. For example, the logic can be optimally located to attain a more favorable computational load or promote efficiency of communication between the applications.

The host application 114 can respond to the condition of an increase in logical unit size by communicating a host operating system directive to adopt the increased logical unit size. Similarly, the host application 114 responds to a condition of a decrease in logical unit size by communicating to the host operating system directive to adopt the decreased logical unit size.

In a particular implementation, the management application 110 can modify the size of the logical units 108 using selectively configurable increments and decrements to fit the storage space usage. The management application 110 initiates an increase to logical unit size when the storage usage increases above a predetermined upper bound and reduces logical unit size when the storage usage decreases below a predetermined lower bound. The management application communicates a request with logic inside the storage array 104 which does the actual task of resizing the LUN.

The logic 102 can maintain logical unit size allocation approximately proportional to file system size and modify the size of the logical units 108 while maintaining the logical units online and while accepting input/output traffic.

Accordingly, in the illustrative system 100, a process on the host 116 monitors actual size used in the host file system, for example the file system of Windows NT (NTFS). When the actual space used approaches a configurable high water mark on logical unit size, the logical unit 108 is grown. Similarly when the actual space used approaches the configurable low water mark on logical unit size, the logical unit 108 is shrunk. The amount to grow or shrink can be a configurable increment, for example specified in gigabytes. Thus the actual logical unit allocation remains proportional to the file system size. In addition, the logical unit 108 subject to size modification remains online, accepting input/output operations (I/Os), during grow and shrink operations.

The illustrative technique exploits capabilities of an operating system which supports online growth and shrink capabilities such as a Windows 2008 Server, in combination with an array that supports online growth and shrinkage, for example Enterprise Virtual Array (EVA) storage which is produced by Hewlett-Packard Company of Palo Alto, Calif. The illustrative system 100 can combine such operating system and storage functionality, in combination with the host application 114 and the management application 110, to produce improved-performance thin provisioning.

With the system 100, spindle space used for data in a logical unit 108 remains proportional to the amount of user data on the logical unit 108. In traditional thin provisioning in environments which experience common input/output patterns, a not unusual condition is that space requirements grow faster than the amount of user data, eventually requiring nearly the same amount of bytes as the logical unit alone. Less spindle usage translates to reduced power consumption, space, and system cost, improving the green capability of block storage.

In the configuration depicted in FIG. 1A, the system 100 further comprises a management server 118, with the management application 110 portion of the logic 102 executable in the management server 118 to manage access of the plurality of applications to the storage array 104.

In another example embodiment, the system 100 can further comprise the storage array 104, with the logic 102 executable to manage access of the plurality of applications to the storage array 104. In various implementations, the management application 110 can execute from a device such as a management server, the storage array 104 as shown in FIG. 1B, the host, other management device such as a storage controller, network controller, or other suitable device.

In various embodiments, the system 100 can comprise one or more devices such as hosts, clients, servers, storage arrays, array controllers, management servers, management devices, and the like. The logic 102 can be executable in the device or devices for managing access to one or more storage arrays. The logic can execute from a single device or can have execution distributed among multiple devices.

Referring to FIG. 1B, an embodiment of a system 100B can comprise a logic that manages access of a plurality of applications to a storage array 104 by receiving information of storage space usage in a file system 124, and modifying size of logical units 108 by selective increases and decreases based on the storage usage. In the illustrative example, the logic can be the management application shown in the array controller 120 but which can execute from other devices, such as within the storage array 104 for an array including an internal controller or processor.

The logic can receive the information, as shown in FIG. 1B, from a device separate from the array controller 120 or storage array 104, such as from the host 116, although any suitable device can be used. The separate device, for example the host 116, monitors storage space usage and sends the information reflective of storage space usage to the array controller 120 or storage array 104 which executes the logical unit size modification.

In another embodiment of a computer-executed system, a logic can manage access of a plurality of applications to a storage array 104 by monitoring storage space usage in a file system 124, and sending information relating to the storage space usage to a device, for example the storage array 104 or array controller 120, that modifies size of logical units by selective increases and decreases based on the storage usage.

Referring again to FIG. 1B, in a further embodiment a system 100B can have two components, an array controller 120 and a host agent 122. The host agent 122 resides on the host 116 which contains the presented logical unit 108, and monitors the size of the file system 106. The logical unit size can be reported back to the array controller 120 on a periodic basis. When the array controller 120 detects a sufficiently large mismatch between logical unit size and file system size, a logical unit grow or shrink operation is triggered.

One aspect of the improved thin provisioning approach is interaction with the host file system 124. On a grow operation, the logical unit 108 is extended and the host agent 122 engages the host operating system 126 to adopt the new logical unit size. On a shrink, a similar operation occurs, except the shrink can take an extended time if the host operating system 126 has to move logical unit blocks to accommodate the shrink.

One example host operating system that supports logical unit shrink and grow operations is Windows 2008 Server.

All thin provisioning techniques operate subject to a condition of a run on storage space which results in an over-commit. If a file system is growing and the system cannot grow the underlying logical unit due to lack of storage space, then the logical unit can become inoperative. A typical case occurs when spindle space in the underlying disk group is used to capacity. The illustrative improved thin provisioning technique facilitates operation in the over-commit condition since the true logical unit size is known by the operating system. Thus, in an over-commit condition, the operating system can use available mechanisms to handle and produce an alarm on the condition. In contrast, in a traditional thin provisioning application a write simply fails with no warning to the operating system.

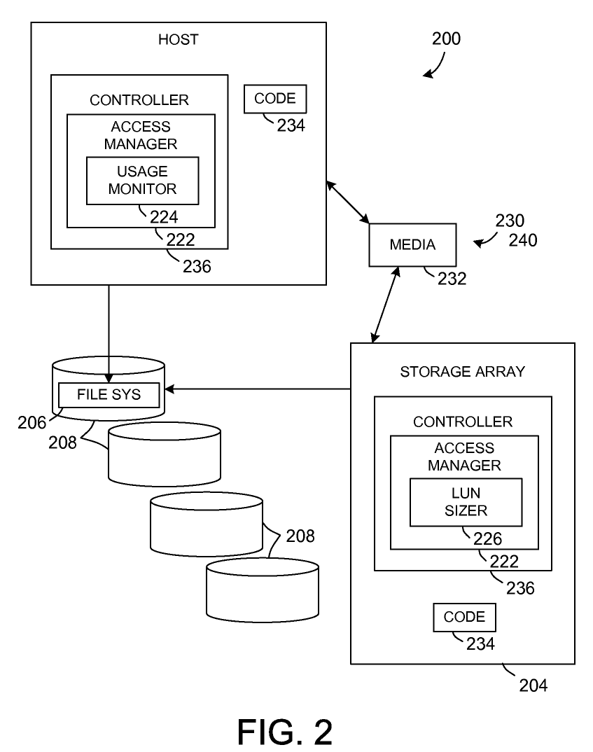

Referring to FIG. 2, a schematic block diagram illustrates another embodiment of a computer-implemented system 200 that reduces power and resource costs of block thin provisioning. The computer-implemented system 200 can comprise means 222 for managing access of a plurality of applications to a storage array 204. The means 222 for managing storage array access can comprise means 224 for monitoring storage space usage in a file system 206, and means 226 for modifying the size of logical units 208 by selective increases and decreases based on the storage usage.

In an example embodiment, the computer-implemented system 200 can be in the form of an article of manufacture 230 comprising a controller-usable medium 232 having a computer readable program code 234 embodied in a controller 236 for performing block thin provisioning with reduced power and resource costs. The computer readable program code 234 comprises code causing the controller 236 to monitor storage space usage in a file system 206, and code causing the controller 236 to modify size of logical units 208 by selective increases and decreases based on the storage usage. Code can also be included that causes the controller 236 to maintain logical unit size allocation approximately proportional to file system size. In another aspect of operation, code can be included to cause the controller 236 to modify size of the logical units 208 while maintaining the logical units online and accepting input/output traffic.

In another aspect of the computer-implemented system 200, a computer program product 240 for managing access of a plurality of applications to a storage array 204 comprises a computer-readable medium 232 tangibly embodying computer-executable code 234. The code 234 includes a first code for monitoring storage space usage in a file system 206, and a second code for modifying size of logical units 208 by selective increases and decreases based on the storage usage.

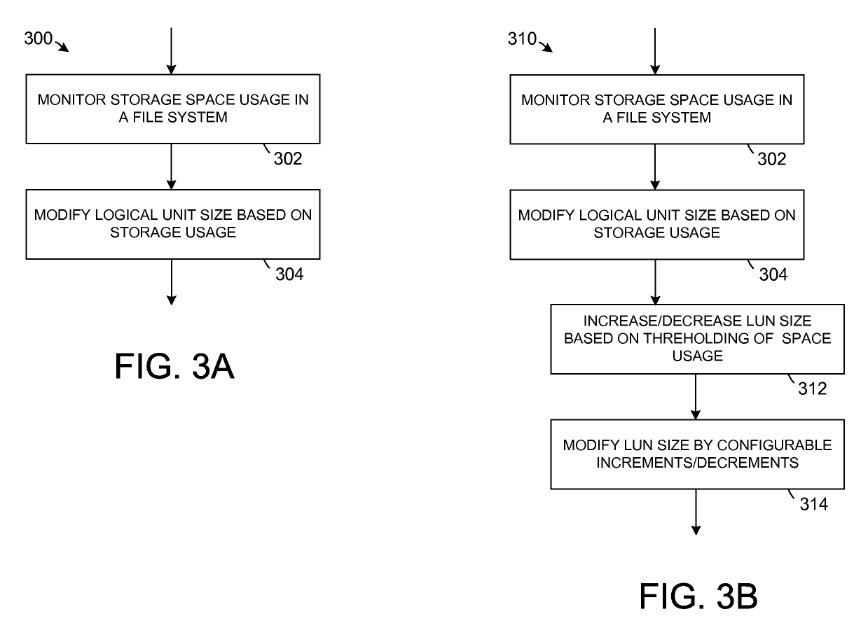

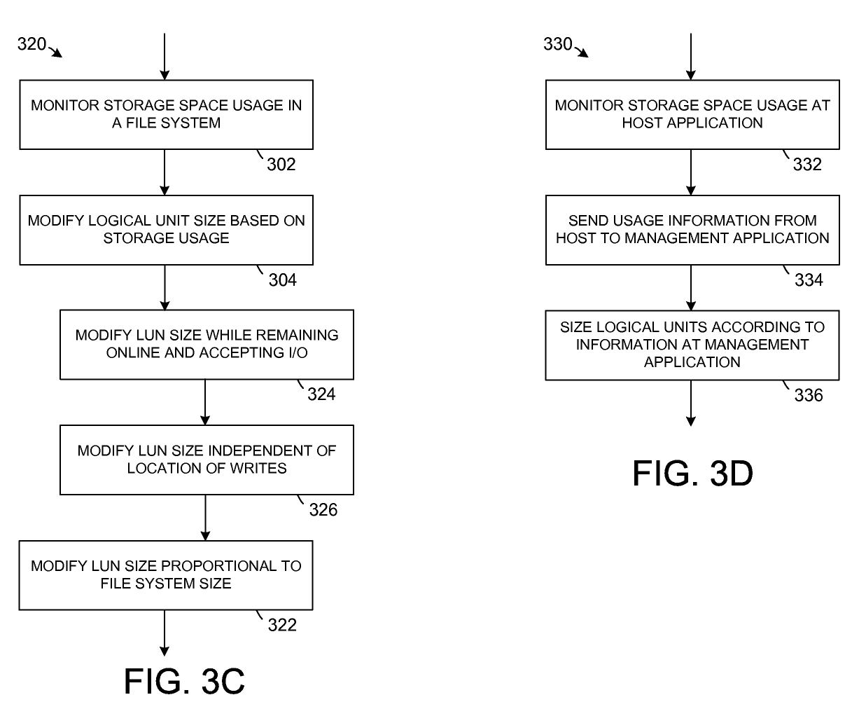

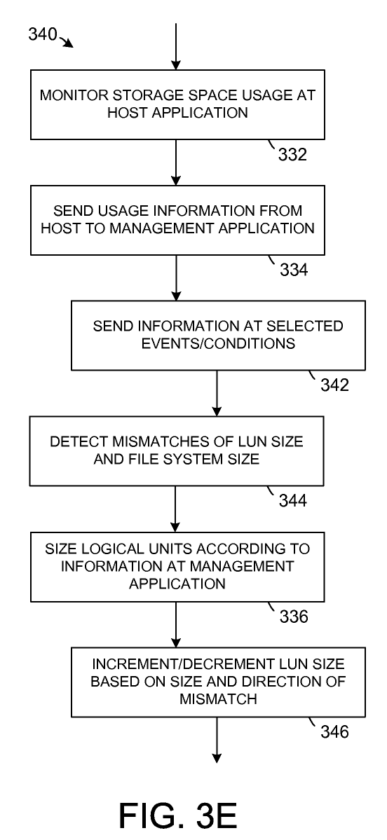

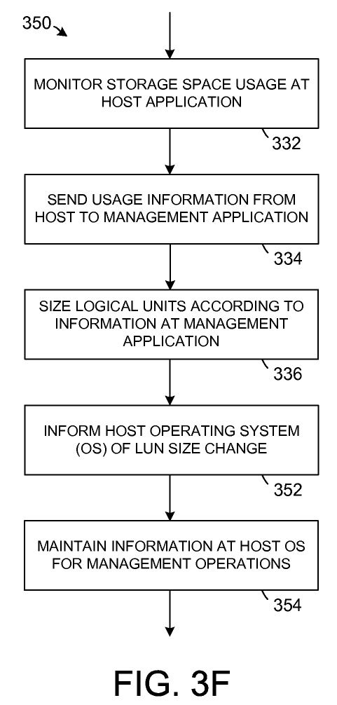

Referring to FIGS. 3A through 3F, flow charts illustrate one or more embodiments or aspects of a computer-executed method that reduces power and resource costs of block thin provisioning. FIG. 3A depicts a computer-executed method 300 for managing access of a plurality of applications to a storage array comprising monitoring 302 storage space usage in a file system, and modifying 304 size of logical units by selective increases and decreases based on the storage usage.

In an example implementation, the quantity of actual data in use by a host application can be monitored 304 in a block storage array.

Referring to FIG. 3B, in an example implementation 310 the size of the logical units can be modified 312 to fit the storage space usage comprising increasing logical unit size when the storage usage increased above a predetermined upper bound and reducing logical unit size when the storage usage decreases below a predetermined lower bound. The size of the logical units by can be modified 314 selectively configurable increments and decrements.

Referring to FIG. 3C, an embodiment of a computer-executed method 320 for managing access of a plurality of applications to a storage array can further comprise maintaining 322 logical unit size allocation approximately proportional to file system size.

The size of the logical units can be modified 324 while maintaining the logical units online and during acceptance of input/output traffic. In some operating systems, some of the steps may involve small pauses in input/output traffic acceptance while parts of the process are executed.

The size of the logical units can be modified 326 independently of location of writes on the logical units. Size of a logical unit is independent of location of writes on the logical unit. In most traditional thin provisioning implementations, once a write operation is applied to a logical unit logical block address (LBA), that part of the logical unit is forever allocated. In the illustrative improved thin provisioning technique, the size of the file system on the logical unit is monitored, enabling deallocation of logical unit space.

As shown in FIG. 3D, a computer-executed method 330 that reduces power and resource costs of block thin provisioning can comprise monitoring 332 the storage space usage at a host application executing on a host which contains the logical units that are presented and sized, and sending 334 information of the storage space usage from the host application to the management application. The size of the logical units can be modified 336 to fit the storage space usage at the management application.

Referring to FIG. 3E, a computer-executed method 340 can further comprise sending 342 information of the storage space usage from the host application to a management application at selected events or conditions. Events and conditions can include timed events such as timing interrupts or program execution counts, interrupts, or other triggers originating either in the host application, management application, or other source. The method 340 can further comprise detecting 344 mismatches between logical unit size and file system size, and modifying 346 size of the logical unit by increasing or decreasing logical unit size based on magnitude and direction of the mismatch. Mismatches can be detected 344 either in the management application or host application for various implementations.

Referring to FIG. 3F, a method 350 can further comprise informing 352 the host operating system of modification of logical unit size. For a modification in logical unit size, the host application can communicate to the host operating system a directive to adopt the modified logical unit size.

Accordingly, the host operating system can maintain 354 current information of logical unit size, enabling the host operating system to perform management operations based on the logical unit size.

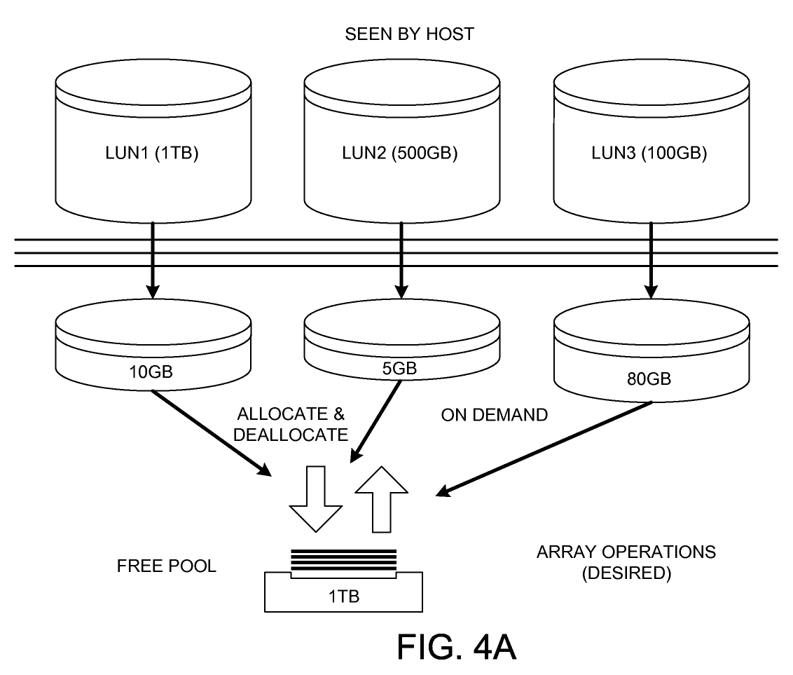

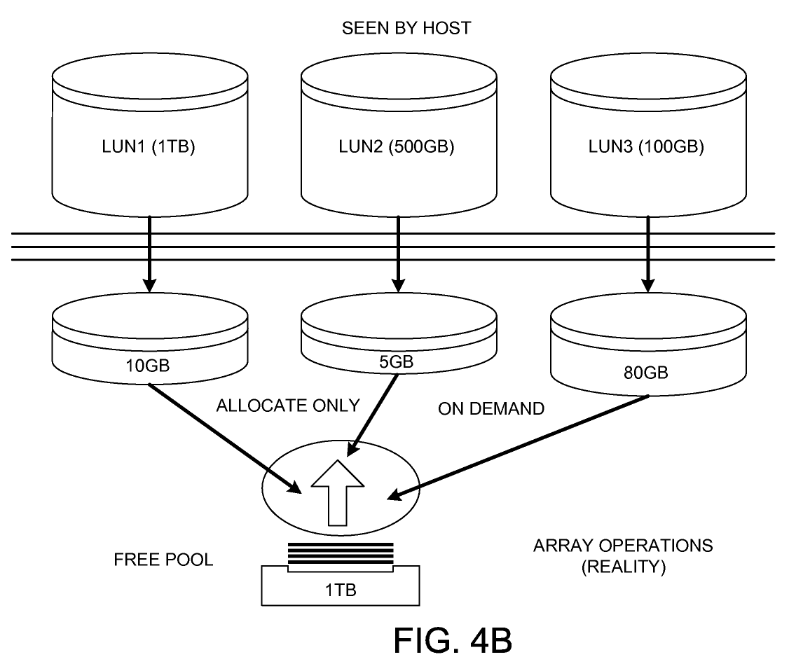

Referring to FIGS. 4A and 4B, block and pictorial diagrams illustrate operation of traditional thin provisioning in block storage, showing storage as seen by a host in comparison to actual operation of the array. FIG. 4A shows the desired operation of thin provisioning. FIG. 4B illustrates actual traditional thin provisioning performance. What is desired is the deallocation as well as allocation of resources on the disk, but what actually occurs is that storage is allocated but not deallocated. Traditional thin provisioning thus has difficulty with block input/output operations to the logical units. The array has no interaction with the operating system and thus has no information regarding file system layout. The only information which can be discerned is whether a block has been written. Most operating systems tend to scatter writes across the logical unit whether the file system is growing, remaining constant in size, or is reduced in size. Examples of operations that can scatter writes include aggressive formatting, file deletion and creation, temporary file creation, defragmentation, and the like. In traditional thin provisioning, allocated space can never shrink and generally grows as long as the logical unit is active, whether or not the actual used space is growing.

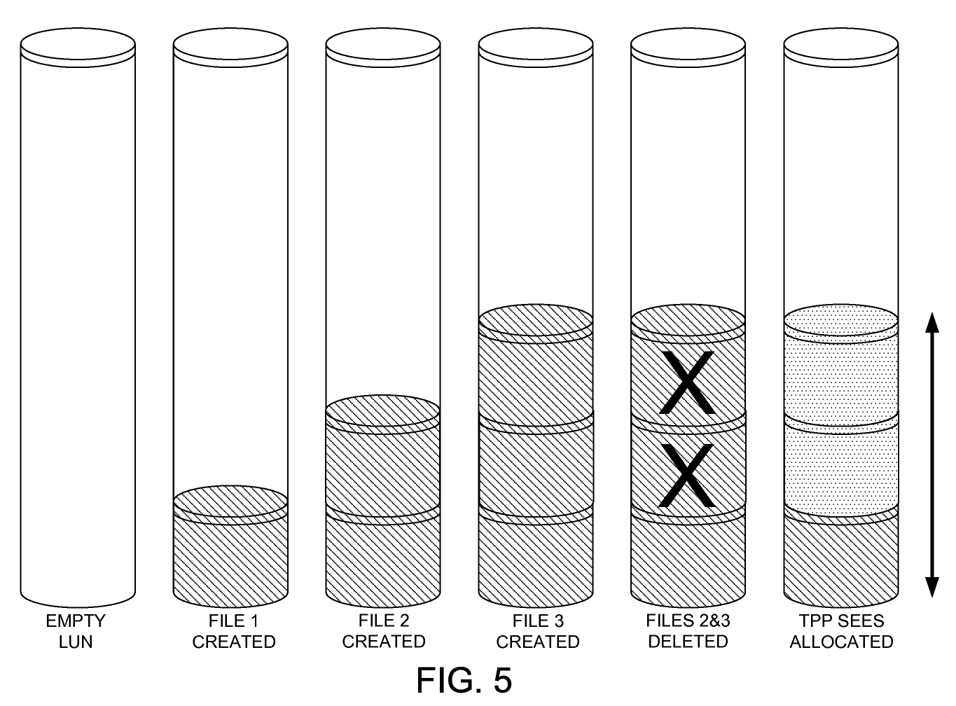

FIG. 5 is a pictorial view showing consequences of traditional thin provisioning. A file (1) is created in an empty logical unit, followed by creation of files 2 and 3. After files 2 and 3 are deleted, the storage space for all three files 1, 2, and 3 remain allocated even after file deletion when traditional thin provisioning is applied.

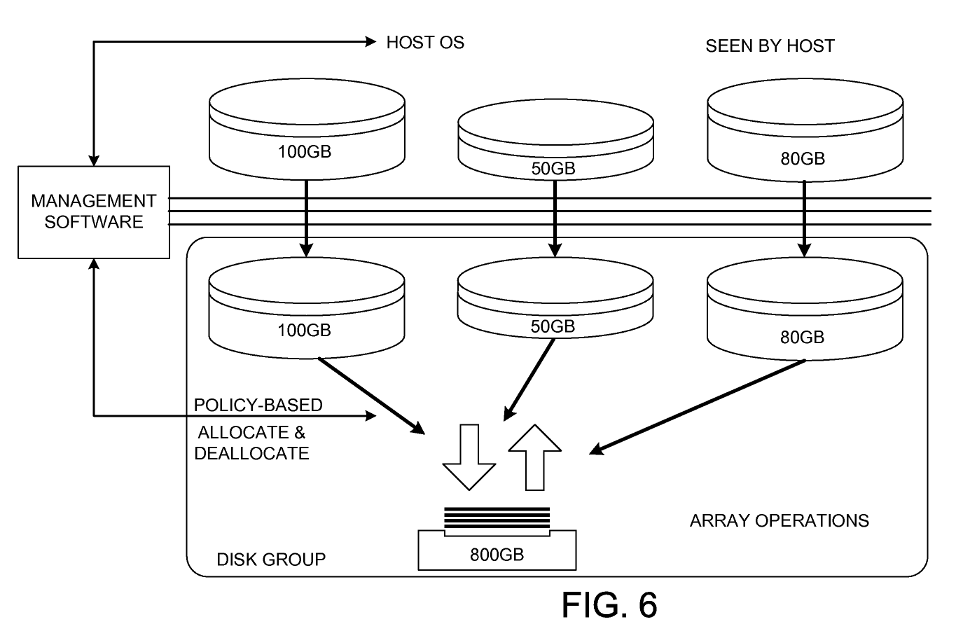

FIG. 6 is a pictorial diagram showing operation of the illustrative improved thin provisioning. A management application 610 enables monitoring of actual file system usage to enable both allocation and deallocation of logical unit size based on actual storage usage. The disclosed thin provisioning technique is host-aware and includes interaction with the operating system, enabling operation based on information relating to actual free space usage at any time. Host-aware thin provisioning does not track which blocks contain in-use data but such tracking is immaterial since the host operating system, for example Windows 2008 Server, understands which blocks contain in-use data, and has the ability to compress the LUN and corresponding partition to support logical unit reduction in size.

In host-aware thin provisioning, allocated space can shrink as well as grow and the amount of allocated space truly mirrors actual used space, enabling an improved over-commit performance since the operating system has information regarding a condition that storage space is running low.

Host-aware thin provisioning enables presentation of logical units which are backed by actual allocation on storage spindles. Logical unit size is trimmed, for example by host-aware thin provisioning logic, to be close to the actual storage needs of the file system contained on the logical unit. As the file system grows, the logical unit grows. As the file system shrinks, the logical unit shrinks.

The illustrative improved thin provisioning technique, which is also termed host-aware thin provisioning is highly beneficial in conditions of several host input/output patterns including logical unit defragmentation, and file grow or create operations without corresponding reduction operations occurring in the near timeframe. The technique is also useful for periodic large file copy operations on the same logical unit which tend to grow the allocation size and, at a later point when the copies are deleted, a number of additional blocks on the logical unit are allocated. Another condition is a sequence of one or more file delete operations without corresponding file create operations, which can for example occur in the case of a movement of a database from one logical unit to another. Improved thin provisioning is also useful for tools which scan each logical unit sector to detect write failures, and scrub tools that zero the logical unit, for example those used by government and department of defense requirement. The technique is also useful with diagnostic and test tools that allocate large portions of an entire logical unit on a temporary basis to perform a run, thereby leaving the logical unit largely allocated while the file system size on the logical unit remains relatively small. Improved thin provisioning is also useful in conditions of a data pattern that slowly cycles the logical unit between very full and very empty, and in which the full and empty periods persist for some time, for example hours.

Terms “substantially”, “essentially”, or “approximately”, that may be used herein, relate to an industry-accepted tolerance to the corresponding term. Such an industry-accepted tolerance ranges from less than one percent to twenty percent and corresponds to, but is not limited to, functionality, values, process variations, sizes, operating speeds, and the like. The term “coupled”, as may be used herein, includes direct coupling and indirect coupling via another component, element, circuit, or module where, for indirect coupling, the intervening component, element, circuit, or module does not modify the information of a signal but may adjust its current level, voltage level, and/or power level. Inferred coupling, for example where one element is coupled to another element by inference, includes direct and indirect coupling between two elements in the same manner as “coupled”.

The illustrative block diagrams and flow charts depict process steps or blocks that may represent modules, segments, or portions of code that include one or more executable instructions for implementing specific logical functions or steps in the process. Although the particular examples illustrate specific process steps or acts, many alternative implementations are possible and commonly made by simple design choice. Acts and steps may be executed in different order from the specific description herein, based on considerations of function, purpose, conformance to standard, legacy structure, and the like.

While the present disclosure describes various embodiments, these embodiments are to be understood as illustrative and do not limit the claim scope. Many variations, modifications, additions and improvements of the described embodiments are possible. For example, those having ordinary skill in the art will readily implement the steps necessary to provide the structures and methods disclosed herein, and will understand that the process parameters, materials, and dimensions are given by way of example only. The parameters, materials, and dimensions can be varied to achieve the desired structure as well as modifications, which are within the scope of the claims. Variations and modifications of the embodiments disclosed herein may also be made while remaining within the scope of the following claims.

What is claimed is:

1. A computer-executed method for managing access of a plurality of applications to a storage array comprising:
monitoring storage space usage in a file system; and
modifying size of logical units by selective increases and decreases based on the storage usage.

2. The method according to claim 1 further comprising:
modifying size of the logical units to fit the storage space usage comprising increasing logical unit size when the storage usage increased above a predetermined upper bound and reducing logical unit size when the storage usage decreases below a predetermined lower bound; and
modifying size of the logical units by selectively configurable increments and decrements.

3. The method according to claim 1 further comprising:
maintaining logical unit size allocation approximately proportional to file system size.

4. The method according to claim 1 further comprising:
modifying size of the logical units while maintaining the logical units online and during acceptance of input/output traffic.

5. The method according to claim 1 further comprising:
modifying size of the logical units independently of location of writes on the logical units.

6. The method according to claim 1 further comprising:
monitoring the storage space usage at a host application executing on a host which contains the logical units that are presented and sized;
sending information of the storage space usage from the host application to a management application at selected events;
detecting mismatches between logical unit size and file system size; and
modifying size of the logical units to fit the storage space usage at the management application by increasing or decreasing logical unit size based on magnitude and direction of the mismatch.

7. The method according to claim 6 further comprising:
informing a host operating system of modification of the logical unit size; and
maintaining current information of logical unit size in a host operating system wherein the host operating system can perform management operations based on the logical unit size.

8. A computer-implemented system comprising:
means for managing access of a plurality of applications to a storage array comprising:
means for monitoring storage space usage in a file system; and
means for modifying size of logical units by selective increases and decreases based on the storage usage.

9. The system according to claim 8 further comprising:
an article of manufacture comprising:
a controller-usable medium having a computer readable program code embodied in a controller for managing access of a plurality of applications to a storage array, the computer readable program code further comprising:
code causing the controller to monitor storage space usage in a file system;
code causing the controller to modify size of logical units by selective increases and decreases based on the storage usage;
code causing the controller to maintain logical unit size allocation approximately proportional to file system size; and
code causing the controller to modify size of the logical units while maintaining the logical units online and during acceptance of input/output traffic.

10. A computer-implemented system comprising:
a logic that manages access of a plurality of applications to a storage array by monitoring storage space usage in a file system, and modifying size of logical units by selective increases and decreases based on the storage usage.

11. The system according to claim 10 further comprising:
a management application;
a host application that executes on a host for monitoring storage space usage and sending information of the storage space usage to the management application; and
the management application responsive to the storage space usage information by modifying size of the logical units to fit the storage space usage.

12. The system according to claim 11 further comprising:
the host which contains the logical units that are presented and sized.

13. The system according to claim 11 further comprising:
the host application that sends information of the storage space usage to the management application at selected events;
a logic that detects mismatches between logical unit size and file system size, and modifies size of the logical unit by increasing or decreasing logical unit size based on magnitude and direction of the mismatch; and
the host application operative for an increase in logical unit size by communicating to a host operating system a directive to adopt the increased logical unit size, and operative for a decrease in logical unit size by communicating to the host operating system a directive to adopt the decreased logical unit size.

14. The system according to claim 11 further comprising:
the management application that modifies size of the logical units using selectively configurable increments and decrements to fit the storage space usage comprising increasing logical unit size when the storage usage increased above a predetermined upper bound and reducing logical unit size when the storage usage decreases below a predetermined lower bound.

15. The system according to claim 10 further comprising:
the logic configured to maintain logical unit size allocation approximately proportional to file system size and modify size of the logical units while maintaining the logical units online and during acceptance of input/output traffic.

16. The system according to claim 10 further comprising:
the storage array; and
the logic executable to manage access of the plurality of applications to the storage array.

17. The system according to claim 10 further comprising:
a management server; and
the logic executable in the management server to manage access of the plurality of applications to the storage array.

18. The system according to claim 10 further comprising:
at least one device selected from a group consisting of hosts, clients, servers, storage arrays, array controllers, and management devices; and
the logic executable in the at least one device for managing access to at least one storage array, the logic executable in a single device or distributed among a plurality of devices.

19. A computer-implemented system comprising:
a logic that manages access of a plurality of applications to a storage array by receiving information of storage space usage in a file system, and modifying size of logical units by selective increases and decreases based on the storage usage.

20. A computer-implemented system comprising:
a logic that manages access of a plurality of applications to a storage array by monitoring storage space usage in a file system, and sending information relating to the storage space usage to a device that modifies size of logical units by selective increases and decreases based on the storage usage.
